(19) United States
(12) Patent Application Publication
(10) Pub. No.: US 2026/0111457 A1
(43) Pub. Date: Apr. 23, 2026

(54) KNOWLEDGE AUTHENTICATION FOR ARTIFICIAL INTELLIGENCE-ASSISTED DECISION-MAKING SYSTEMS

(71) Applicant: GM GLOBAL TECHNOLOGY OPERATIONS LLC, DETROIT, MI (US)

(72) Inventor: Armando Antonio Beltran Pacheco, Rochester Hills, MI (US)

(21) Appl. No.: 18/918,650

(22) Filed: Oct. 17, 2024

(51) Int. Cl. G06F 16/332; G06F 21/44

(52) U.S. Cl. CPC G06F 16/3329; G06F 21/44

(57) ABSTRACT

Examples described herein provide a method for knowledge authentication for artificial intelligence-assisted decision making. The method includes receiving knowledge from a subject matter expert and authenticating the knowledge based on structured decision-making information. The method further includes generating an efficiency index for individual uses of the knowledge, wherein the efficiency index measures a sequence and efficiency of decisions and approaches taken towards solving a problem. The method further includes storing authenticated knowledge and the efficiency index, wherein the authenticated knowledge represents know-how that can be distributed with a level of certainty about its usability. The method further includes generating, using a trained machine learning model, a response to a user query using the authenticated knowledge and the efficiency index.

### BACKGROUND

The subject disclosure relates to artificial intelligence-based computing systems, and in particular to knowledge authentication for artificial intelligence (AI)-assisted decision-making systems.

Decision-making is the process of choosing the best course of action from various options to achieve specific goals. In industrial settings (e.g., auto manufacturing, aerospace manufacturing, and/or the like), decision-making is important because decisions directly impact efficiency, performance, and overall success. Effective decision-making ensures resources are used optimally, processes run smoothly, and potential problems are addressed proactively or avoided altogether. This is useful for maintaining operational stability, meeting production goals, and staying competitive in a dynamic market. Sound decision-making supports long-term growth and sustainability, making it a cornerstone of successful industrial management.

Expert knowledge in decision-making processes within industrial environments, such as automotive or aerospace manufacturing, involves leveraging specialized understanding of complex systems, production workflows, and industry-specific challenges to optimize operations. This expertise often includes a deep familiarity with manufacturing technologies, supply chain logistics, product designs, and quality control standards. Experts use this knowledge to analyze data, identify potential risks, and implement strategies that enhance efficiency, reduce costs, and maintain high safety and quality standards. Additionally, experts often integrate advanced tools like predictive analytics, artificial intelligence, and automation to support real-time decision-making, ensuring the continuous improvement of production processes in a highly competitive and regulated environment. It may be desirable to authenticate knowledge for AI-assisted decision-making systems, thereby ensuring that the knowledge provided is accurate, reliable, and comes from valid sources.

### SUMMARY

In one embodiment, a method for knowledge authentication for artificial intelligence-assisted decision making is provided. The method includes receiving knowledge from a subject matter expert and authenticating the knowledge based on structured decision-making information. The method further includes generating an efficiency index for individual uses of the knowledge, wherein the efficiency index measures a sequence and efficiency of decisions and approaches taken towards solving a problem. The method further includes storing authenticated knowledge and the efficiency index, wherein the authenticated knowledge represents know-how that can be distributed with a level of certainty about its usability. The method further includes generating, using a trained machine learning model, a response to a user query using the authenticated knowledge and the efficiency index.

In addition to one or more of the features described herein, or as an alternative, further embodiments of the method may include that the knowledge includes at least one of an opinion, an approach to the problem, or a recommendation.

In addition to one or more of the features described herein, or as an alternative, further embodiments of the method may include that the knowledge is implicit knowledge, wherein the trained machine learning model generates the response using the authenticated knowledge and the efficiency index.

In addition to one or more of the features described herein, or as an alternative, further embodiments of the method may include that the efficiency index is one of a plurality of efficiency indices for solving the problem.

In addition to one or more of the features described herein, or as an alternative, further embodiments of the method may include ranking the plurality of efficiency indices for solving the problem.

In addition to one or more of the features described herein, or as an alternative, further embodiments of the method may include that the ranking is based at least in part on a confidence of each of the plurality of efficiency indices solving the problem.

In addition to one or more of the features described herein, or as an alternative, further embodiments of the method may include that generating the efficiency index is performed using a random walk model.

In addition to one or more of the features described herein, or as an alternative, further embodiments of the method may include that the efficiency index is calculated using the following equation:

$${\sum }_{0}^{m} {\prod }_{0}^{n} {( {D}_{n} {PA}_{n} )}_{m}$$

where m is a number of branches, n is a total number of nodes per branch, and PA represents a P index or A index value for a given n and m.

In another embodiment, a processing system is provided. The processing system includes a memory having computer readable instructions and a processing device for executing the computer readable instructions, the computer readable instructions controlling the processing system to perform operations for knowledge authentication for artificial intelligence-assisted decision making. The operations include receiving knowledge from a subject matter expert. The operations further include authenticating the knowledge based on structured decision-making information. The operations further include generating an efficiency index for individual uses of the knowledge, wherein the efficiency index measures a sequence and efficiency of decisions and approaches taken towards solving a problem. The operations further include storing authenticated knowledge and the efficiency index, wherein the authenticated knowledge represents know-how that can be distributed with a level of certainty about its usability. The operations further include generating, using a trained machine learning model, a response to a user query using the authenticated knowledge and the efficiency index.

In addition to one or more of the features described herein, or as an alternative, further embodiments of the processing system may include that the knowledge includes at least one of an opinion, an approach to the problem, or a recommendation.

In addition to one or more of the features described herein, or as an alternative, further embodiments of the processing system may include that the knowledge is implicit knowledge, wherein the trained machine learning model generates the response using the authenticated knowledge and the efficiency index.

In addition to one or more of the features described herein, or as an alternative, further embodiments of the processing system may include that the efficiency index is one of a plurality of efficiency indices for solving the problem.

In addition to one or more of the features described herein, or as an alternative, further embodiments of the processing system may include that the operations further include ranking the plurality of efficiency indices for solving the problem.

In addition to one or more of the features described herein, or as an alternative, further embodiments of the processing system may include that the ranking is based at least in part on a confidence of each of the plurality of efficiency indices solving the problem.

In addition to one or more of the features described herein, or as an alternative, further embodiments of the processing system may include that generating the efficiency index is performed using a random walk model.

In addition to one or more of the features described herein, or as an alternative, further embodiments of the processing system may include that the efficiency index is calculated using the following equation:

$${\sum }_{0}^{m} {\prod }_{0}^{n} {( {D}_{n} {PA}_{n} )}_{m}$$

where m is a number of branches, n is a total number of nodes per branch, and PA represents a P index or A index value for a given n and m.

In another embodiment a computer program product is provided. The computer program product includes a computer readable storage medium having program instructions embodied therewith, the program instructions executable by at least one processor to cause the at least one processor to perform operations for performing knowledge authentication for artificial intelligence-assisted decision making. The operations include receiving knowledge from a subject matter expert. The operations further include authenticating the knowledge based on structured decision-making information. The operations further include generating an efficiency index for individual uses of the knowledge, wherein the efficiency index measures a sequence and efficiency of decisions and approaches taken towards solving a problem. The operations further include storing authenticated knowledge and the efficiency index, wherein the authenticated knowledge represents know-how that can be distributed with a level of certainty about its usability. The operations further include generating, using a trained machine learning model, a response to a user query using the authenticated knowledge and the efficiency index.

In addition to one or more of the features described herein, or as an alternative, further embodiments of the computer program product may include that the efficiency index is one of a plurality of efficiency indices for solving the problem, wherein the operations further include ranking the plurality of efficiency indices for solving the problem, and wherein the ranking is based at least in part on a confidence of each of the plurality of efficiency indices solving the problem.

In addition to one or more of the features described herein, or as an alternative, further embodiments of the computer program product may include that generating the efficiency index is performed using a random walk model.

In addition to one or more of the features described herein, or as an alternative, further embodiments of the computer program product may include that the efficiency index is calculated using the following equation:

$${\sum }_{0}^{m} {\prod }_{0}^{n} {( {D}_{n} {PA}_{n} )}_{m}$$

where m is a number of branches, n is a total number of nodes per branch, and PA represents a P index or A index value for a given n and m.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a block diagram of a system for knowledge authentication for artificial intelligence (AI)-assisted decision-making systems according to one or more embodiments;

FIG. 2 illustrates a block diagram of a system for knowledge authentication for AI-assisted decision-making systems according to one or more embodiments;

FIG. 3 illustrates a map of structured decision-making for goal oriented problem solving according to one or more embodiments;

FIG. 4 illustrates a flow diagram of a method for knowledge authentication for AI-assisted decision-making according to one or more embodiments; and

FIG. 5 illustrates a block diagram of a system for knowledge authentication for AI-assisted decision-making systems according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to knowledge authentication for artificial intelligence (AI)-assisted decision-making systems.

Technological systems often face challenges related to the quality of data input, commonly referred to as the “garbage in, garbage out” problem. This issue arises when the data fed into these systems lacks the necessary depth and context, leading to suboptimal performance and unreliable outputs. Existing approaches to decision-making systems primarily focus on explicit knowledge, which includes easily documented information, such as facts and instructions. However, these approaches often overlook implicit knowledge (e.g., knowledge of a skilled person or expert), which encompasses the nuanced understanding and experience gained through real-life interactions and problem-solving.

Implicit knowledge, also known as intangible “know-how,” plays a role in decision-making processes, particularly in goal-oriented problem-solving tasks. Implicit knowledge is the knowledge or understanding gained through real-life experience. For example, implicit knowledge is the “know how” that explains the procedure used to complete a task, which thrives on context and experience. Traditional approaches to capturing this type of knowledge are either intrusive or fail to systematically document the decision-making process. As a result, systems lack the comprehensive data for generating accurate and contextually relevant responses.

In knowledge management systems, it can be difficult to ensure the accuracy and reliability of knowledge utilized in decision-making processes. The proliferation of large language models (LLMs) and synthetic information has made access to vast amounts of data easier. However, the lack of systematic validation mechanisms can lead to inefficiencies and the dissemination of non-validated information. This issue is particularly pronounced where the reliability of knowledge provided by automated systems or individuals remains uncertain.

Existing solutions often fail to authenticate the knowledge provided by subject matter experts (SMEs) and automated systems, leading to potential “hallucinations” or incorrect information that can negatively impact task completion and decision-making processes. The absence of a structured approach to validate and measure the effectiveness of knowledge used in problem-solving further exacerbates these challenges. There is a desire for a systematic approach to authenticating knowledge and ensuring usability and reliability across various organizational contexts.

One or more embodiments described herein addresses these shortcomings by providing a comprehensive and systematic approach to authenticate and measure the effectiveness of knowledge used in problem-solving and decision-making processes. One or more embodiments employs an algorithm to systematically authenticate knowledge, generating an efficiency index that measures the sequence and efficiency of decisions and approaches taken towards solving a problem. One or more embodiments stores validated knowledge in a database along with the efficiency metric, ensuring that the knowledge distributed is valid and ranked based on the proven usability.

By implementing this approach, one or more embodiments enables intelligent data analytics strategies applicable for explicit and implicit knowledge across individuals, functional groups, and the entire organization. One or more embodiments incorporates a random walk model to measure the efficiency of the problem-solving process, assessing how decision paths in the solution process are efficient and the impact of external stimuli, such as input from subject matter experts, converge to an effective solution. This structured approach provides a reliable repository of usable know-how, enhancing the accuracy and reliability of knowledge utilized in decision-making processes.

Goal-oriented problem-solving involves a decision-making process (“why”) that determines tasks to perform for accomplishing a goal (“what”) based on explicit knowledge and implicit knowledge (“how”). Knowledge differs from information. Information can be seen as data that has been organized or processed in a way that adds context or meaning. Information includes raw facts and figures, for example, that have been structured but not yet interpreted or fully understood. Knowledge goes a step beyond information in that knowledge encompasses the understanding, interpretation, and application of information. Knowledge is information that has been processed by a human mind through learning, experience, and/or instruction. For example, when data is received, it can be processed to generate information. The processing can take documentation templates and formats and apply the data to them to generate design requirements, guidelines, and/or standards, for example, which is the generated information. The information can then be used by a human user using the human user's experience and intuition to derive knowledge from the information. The knowledge is acquired through learning and can be shared with others.

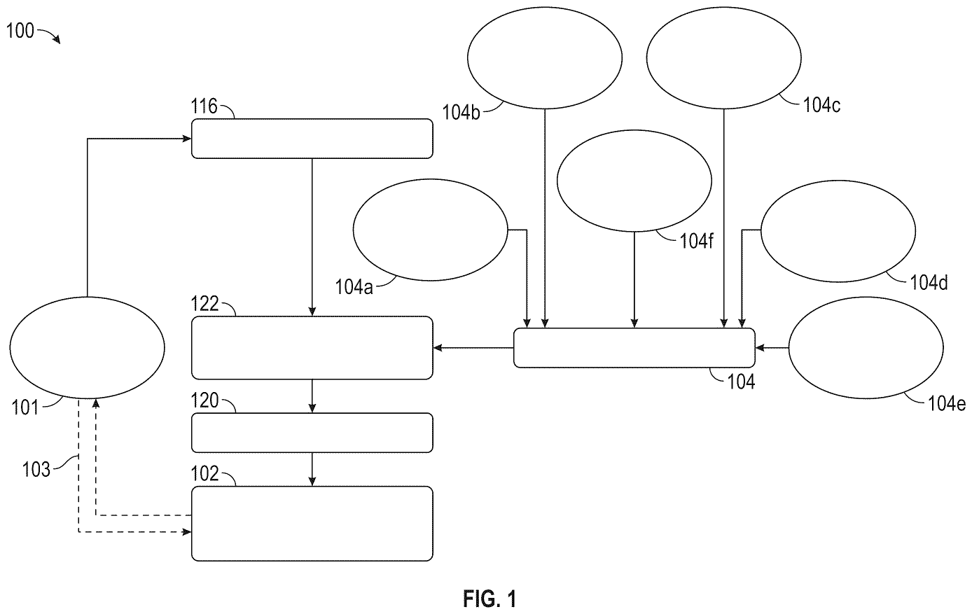

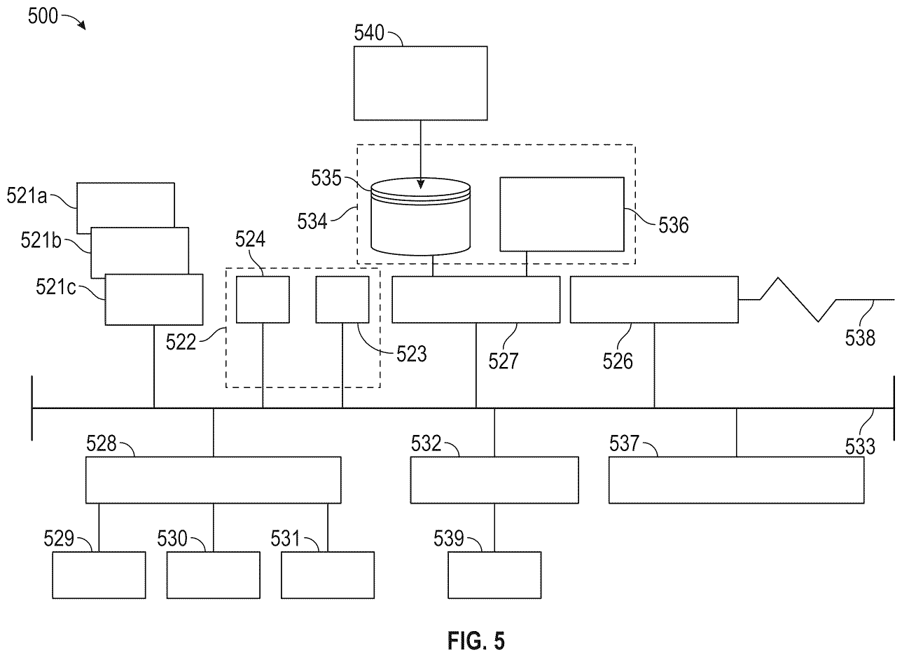

FIG. 1 illustrates a block diagram of a system 100 for knowledge authentication for artificial intelligence (AI)-assisted decision-making systems according to one or more embodiments. The system 100 can be implemented in whole or in part using, for example, the processing system 500 of FIG. 5, or another suitable system or device.

A SME 101 interacts with the system 100 to provide implicit knowledge through various user interactions. The actions and decisions of the SME 101 during specific tasks are captured and documented to generate captured implicit knowledge 116. These interactions may include, for example, typing, talking, keyboard flows, click/touch events, and video, which are processed to extract meaningful insights. The SME 101 plays a role in enhancing the quality of data inputs for AI systems by providing nuanced understanding and experience gained through real-life problem-solving.

The captured implicit knowledge 116 refers to the knowledge representations extracted from the raw data collected from the SME 101. This knowledge is systematically documented and categorized to create structured knowledge representations. The captured implicit knowledge 116 includes individual actions and decisions taken during specific tasks, providing insights for AI-assisted decision-making. This knowledge is stored in an implicit knowledge base of a knowledge management system 122, which is utilized by AI systems (e.g., the LLM agent 120) to improve decision-making capabilities.

The LLM agent 120 is an AI system that utilizes large language models to access and utilize the structured knowledge representations stored in the knowledge base. The LLM agent 120 generates responses to user queries (also referred to as “prompts”) based on the captured implicit knowledge 116, enhancing the decision-making capabilities of the AI system. The LLM agent 120 interacts with the knowledge management system 122 to retrieve context and provide accurate and relevant responses, thereby improving the quality of data inputs and enhancing decision-making processes.

The knowledge management system 122 is responsible for organizing and storing the documented implicit knowledge. This system categorizes the knowledge to create structured representations that are accessible and usable for AI systems. The knowledge management system 122 interacts with the implicit knowledge base and the LLM agent 120 to provide a comprehensive knowledge management solution that supports AI-assisted decision-making. The knowledge management system 122 ensures that the captured knowledge is systematically documented and categorized, making the captured knowledge accessible for future use.

The knowledge management system 122 can also utilize explicit knowledge 104, which includes easily documented information, such as facts, instructions, and guidelines. The explicit knowledge 104 is stored in various databases and repositories, such as a calibration guidelines database 104a, production code repositories 104b, configuration management tool/procedures 104c, function SharePoint documents 104d, tool guidelines and processes, standards 104e, internal social networks 104f, and/or the like, including combinations and/or multiples thereof. The explicit knowledge 104 is used in conjunction with the captured implicit knowledge 116 to provide a comprehensive knowledge management solution. According to one or more embodiments, the explicit knowledge 104 is organized and stored in a structured format, making the explicit knowledge 104 accessible for AI systems to enhance decision-making capabilities.

The calibration guidelines database 104a stores guidelines and procedures related to calibration processes. The production code repositories 104b store code and scripts related to production processes. The configuration management tool/procedures 104c store tools and procedures related to configuration management. The function SharePoint documents 104d store documents related to specific functions and tasks. The tool guidelines and processes, standards 104e store guidelines, processes, and standards related to various tools and procedures. The internal social networks 104f store information and knowledge shared within internal social networks.

Prompting to support decision-making for problem solving 102 involves a user requesting information for solving a problem. A user can generate a prompt inquiring how to solve a problem, and the LLM agent 120 uses the prompt, as well as the authenticated knowledge as further described herein, to provide a response to aid decision-making to solve the problem identified in the user's prompt. Non-limiting examples of decision making for problem solving 102 include determining which signals to measure, determining what signals to connect, determining what calibrations to modify, determining how to modify a system to meet certain requirements, and/or the like, including combinations and/or multiples thereof.

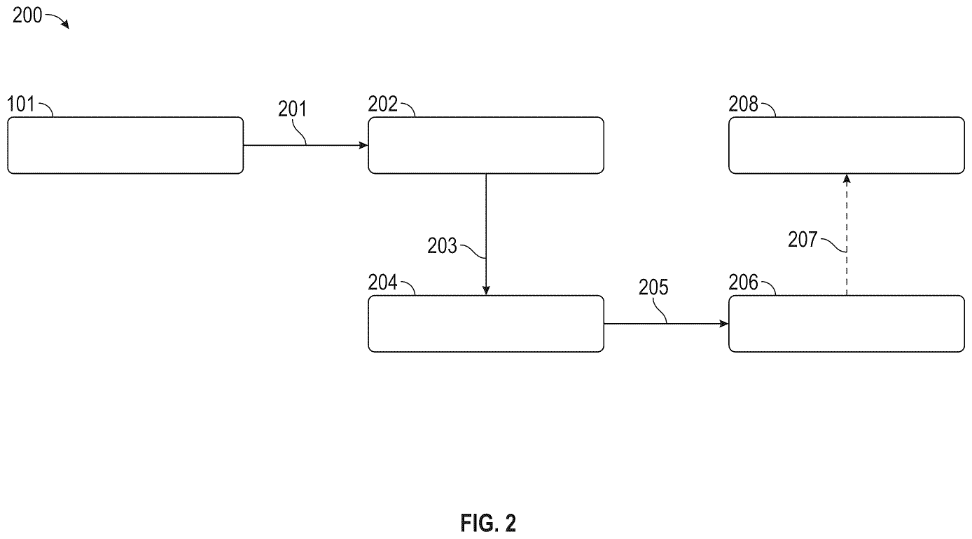

According to one or more embodiments, knowledge authentication 103 is performed by the SME 101 using prompting to support decision-making for problem solving 102. Knowledge authentication 103 (also referred to as cognitive validation) provides for authenticating the implicit knowledge (e.g., the captured implicit knowledge 116) provided by subject matter experts (SMEs) (e.g., the SME 101) and measuring the SME's problem solving process. Authenticating the knowledge ensures that the knowledge provided is accurate, reliable, and comes from validated sources. To perform knowledge authentication 103, the knowledge management system 122 (or another suitable system or device) determines an efficiency index that measures the sequence and efficiency of decisions and approaches taken towards solving a problem. The knowledge authentication 103 provides for the reduction and/or elimination of incorrect information dissemination, the creation of a reliable repository of usable know-how, the improvement of decision-making processes through validated and ranked knowledge, and/or the like, including combinations and/or multiples thereof. The knowledge authentication 103 is further described with respect to FIGS. 2-4.

In particular, FIG. 2 illustrates a block diagram of a system 200 for knowledge authentication for AI-assisted decision-making systems according to one or more embodiments. The system 200 can be implemented in whole or in part using, for example, the processing system 500 of FIG. 5, or another suitable system or device.

The SME 101 provides knowledge 201, which may be an opinion, an approach to a problem, a recommendation, an insight, and/or the like, including combinations and/or multiples thereof, to an individual contributor problem-solving process 202.

The individual contributor problem-solving process 202 involves applying the knowledge 201 to solve a specific problem or make a decision during problem solving. That is, the SME 101 uses the knowledge 201 to solve a problem (e.g., individual contributor problem-solving process 202). For example, a problem may have multiple decision points to be made and/or sub-problems to addressed. The SME 101 applies the knowledge 201 during the individual contributor problem-solving process 202 to make decisions, address problems/sub-problems, implement tasks, etc. The individual contributor problem-solving process 202 captures structured decision-making 203, which defines the framework for how the SME 101 applied the knowledge 201 during the individual contributor problem-solving process 202.

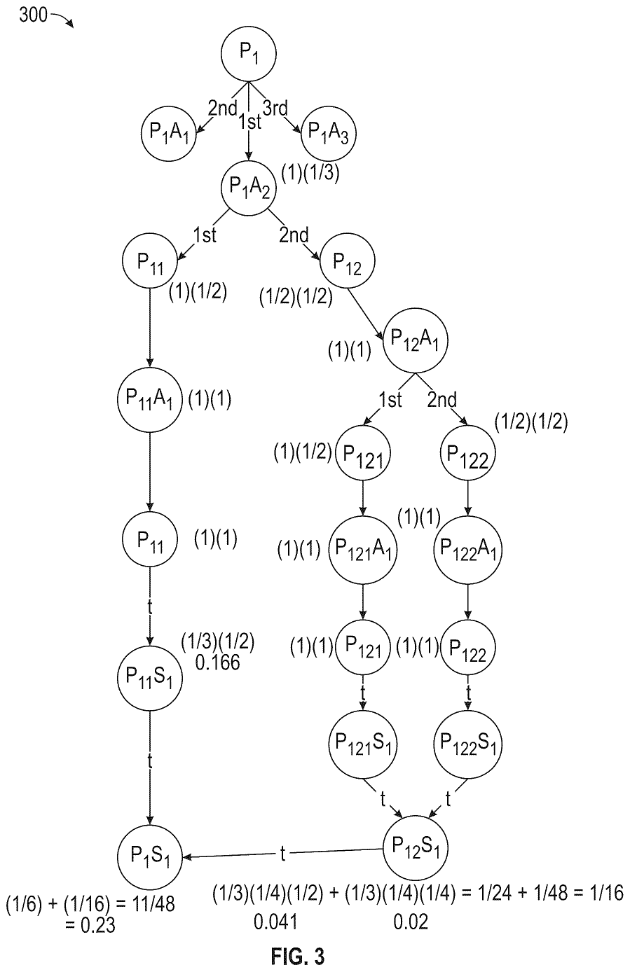

Knowledge systematic authentication 204 uses the structured decision-making 203 to authenticate the knowledge 201. That is, the knowledge systematic authentication 204 performs cognitive validation to authenticate the knowledge 201, ensuring its validity and reliability. The knowledge systematic authentication 204 receives a problem in a descriptive way (e.g., what is the problem actually being solved) and how many approaches or possible solutions are being evaluated. According to one or more embodiments, such information can be received as metadata. The knowledge systematic authentication 204 may include cross-referencing with existing validated knowledge, assessing the credibility of the SME, and verifying the consistency of the information provided. The knowledge systematic authentication 204 generates an efficiency index 205 for the knowledge 201. The efficiency index 205 measures the sequence and efficiency of decisions and approaches taken towards solving a problem. According to one or more embodiments, the efficiency index 205 quantifies the process, including the number and order of decisions, approaches proposed and evaluated, failed approaches, and problem decomposition, which provides a structured way to assess the effectiveness of problem-solving processes. In some embodiments, the efficiency index 205 can identify sources of knowledge based on their applicability and usefulness to multiple users. This index provides a measurable, objective metric to validate the knowledge 201, ensuring that the knowledge 201 is not only accurate but also practically useful in various contexts. The knowledge systematic authentication 204 and the efficiency index 205 are described in more detail herein with reference to FIG. 3.

According to one or more embodiments, the knowledge systematic authentication 204 applies a random walk approach to generate the efficiency index 205. Random walk is a model used in computational modeling that shows how a decision is taken. Random walk may utilize evidence, certain parameters that define how informative received stimuli, and how fast those stimuli are received to converge to take a decision. The random walk is used to measure how effective the external stimuli (e.g., the knowledge 201 of the SME 101) is in helping to converge to a decision that will lead to an effective solution (e.g., an efficiency index with a desired confidence (e.g., greater than a threshold, such as 75% confidence, 80% confidence, 95% confidence, etc.)).

With continued reference to FIG. 2, once the efficiency index 205 is generated, the knowledge 201 is stored as validated knowledge along with the efficiency index 205 in a validated knowledge and efficiency metrics database 206. Knowledge that leads to a solution to a problem is validated knowledge, while knowledge that does not lead to a solution to the problem is not considered validated knowledge but may be used for other purposes (e.g., considered for metrics) in various embodiments. The validated knowledge and efficiency metrics database 206 serves as a reliable repository of validated knowledge that can be distributed with a level of certainty about its usability. The validated knowledge and efficiency metrics database 206 ensures that the validated knowledge is readily accessible for future use and can be reliably referenced in future decision-making processes.

According to one or more embodiments, the validated knowledge and efficiency metrics database 206 can rank efficiency indexes such a higher rated efficiency index indicates a higher confidence for solving a problem than a lower rated efficiency index for solving the problem. That is, there may be multiple efficiency indices for solving a problem, and those efficiency indices can be ranked based on a confidence for solving the problem.

The validated knowledge and efficiency indices stored in the validated knowledge and efficiency metrics database 206 are then utilized in intelligent data analytics 207, which applies advanced data analytics techniques to the validated knowledge, enabling the extraction of valuable insights and patterns that can inform decision-making processes. These insights and patterns derived from the intelligent data analytics 207 are applied in enterprise business analytics 208, which leverages the validated knowledge and efficiency indices to enhance business analytics processes across an organization, improving overall decision-making and problem-solving capabilities.

FIG. 3 illustrates a map 300 of structured decision-making for goal oriented problem solving according to one or more embodiments. The map 300 provides a visual representation of sequences of decisions, approaches, and problem decompositions involved in solving an overall problem P1 and arriving at a solution P1S1.

The process begins with the identification of the overall problem P1 that needs to be solved. This problem serves as the starting point for the decision-making and problem-solving process. The ultimate goal is to derive the solution P1S1.

The SME 101 is presented with three approaches PIA1, P1A2, P1A3 to solve the overall problem P1. The number of approaches indicate how many options the SME 101 considered. The SME 101 can choose approach P1A1, P1A2, or P1A3. The various approaches are different approaches to solving a problem, and the various decisions are decisions that the SME 101 can or does make in the decision-making process. In the example of FIG. 3, the SME 101 elects to evaluate the approach P1A2 first. Because the approach PIA2 yields the solution P1S1, the approaches PIA1 and P1A3 are not evaluated; however, these approaches could be considered in other embodiments, such as where the approach PIA2 does not yield a solution.

In this example, the SME 101 chose approach P1A2, at which point the overall problem P1 is reduced to two problems P11, P12 (which may be considered sub-problems of the overall problem P1) through problem reduction. As shown in FIG. 3, the SME 101 approaches the problem P11 first, and one approach P11A1 is considered as the potential solution to the problem P11. No additional problem reduction is performed as P11 is considered a minimum problem to solve according to approach P11A1, and the solution to P11 is P11S1. The time t used to solve the problem P11 is captured, and an efficiency index given while solving P1 is ⅓.

Returning to the problem reduction of P1A2, the map 300 continues by approaching problem P12. Problem P12 is approached with approach P12A1, which is considered as a potential solution for P12. Problem reduction is again performed as shown such that P12 is reduced into two further problems P121 and P122. Approach P121A1 is taken for problem P121, resulting in the solution to P121 as P121S1. Approach P122A1 is taken for problem P122, resulting in the solution P122S1. The times t used to solve the problems P121 and P122 are captured. The solutions P121S1 and P122S1 are combined into the solution P12S1 for the problem P12.

The solutions P11S1 and P12S1 are then combined to generate the solution P1S1 to the problem P1.

The solutions P11S1 and P12S1 are used to calculate the efficiency index 205 for the solution P1S1 as follows.

Cognitive indexes (knowledge indexes) are as defined as follows:
P is a know-how index, which is 1/total number of problem reductions (TP), thus P=1/TP;
A is an experience index, which is 1/total number of approaches (TA), thus A=1/TA; and
D is an intuition index, which is 1/number order of decision taken (ND), thus P=1/ND.

Decision-making problem-solving nodes are defined as follows:
DP is a decision problem node DP=DₙPₙ, where n is the number of nodes; and
DA is a decision approach node DA=DₙAₙ, where n is the number of nodes.

The efficiency index 205 (DPAE_index) may be calculated using the following equation:

$$DPAE\_index = {\sum }_{0}^{m} {\prod }_{0}^{n} {( {D}_{n} {PA}_{n} )}_{m}$$

where m is a total number of branches, n is a total number of nodes per branch, and PA represents the P index or A index value for a given n and m.

Calculation of the efficiency index 205 (DPAE_index) is now described in accordance with the following example. For the problem P1, which problem-solving decision-making process is represented in the following table, the efficiency index 205 (DPAE_index) is calculated as follows, where m=3, n₁=4, n₂=6, and n₃=6.

| Branch | Node | | Decision | Problem | Approach | Node | Branch | DPAE |
|---|---|---|---|---|---|---|---|---|
| [m] | [n] | Node | [D] | [P] | [A] | Index | Index | Index |
| 1 | 1 | P1A2 | 1 | | 1/3 | 1/3 | | |
| 1 | 2 | P11 | 1 | 1/2 | | 1/2 | | |
| 1 | 3 | P11A1 | 1 | | 1 | 1 | | |
| 1 | 4 | P11 | 1 | | 1 | 1 | 0.167 | |
| 2 | 1 | P1A2 | 1 | | 1/3 | 1/3 | | |
| 2 | 2 | P12 | 1/2 | 1/2 | | 1/4 | | |
| 2 | 3 | P12A1 | 1 | | 1 | 1 | | |
| 2 | 4 | P121 | 1 | | | 1/2 | | |
| 2 | 5 | P121A1 | 1 | | 1 | 1 | | |
| 2 | 6 | P121 | 1 | 1 | | 1 | 0.042 | |
| 3 | 1 | P1A2 | 1 | | 1/3 | 1/3 | | |
| 3 | 2 | P12 | 1/2 | 1/2 | | 1/4 | | |
| 3 | 3 | P12A1 | 1 | | 1 | 1 | | |
| 3 | 4 | P122 | 1/2 | 1/2 | | 1/4 | | |
| 3 | 5 | P122A1 | 1 | | 1 | 1 | | |
| 3 | 6 | P122 | 1 | 1 | | 1 | 0.021 | 0.229 |

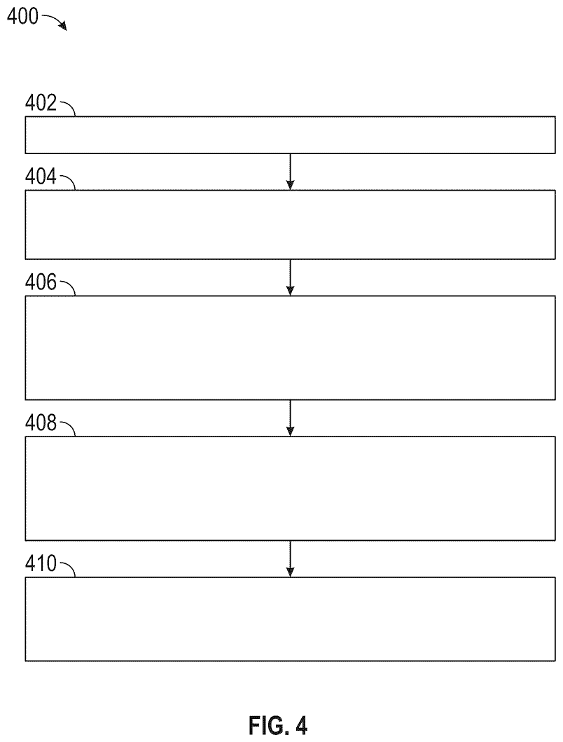

FIG. 4 is a flow diagram of a method 400 for knowledge authentication for AI-assisted decision-making according to one or more embodiments. The method 400 can be implemented using any suitable system or device. For example, the method 400 can be implemented using the processing system 500 of FIG. 5 and/or another suitable system or device. The method 400 is now described with reference to FIGS. 1, 2, and/or 3 but is not so limited.

At block 402, the method 400 begins with receiving knowledge from the SME 101. This knowledge can include insights, recommendations, opinions, advice, and/or the like, including combinations and/or multiples thereof, relevant to specific tasks or decision-making processes.

At block 404, the received knowledge is authenticated based on structured decision-making information. This involves evaluating the source and content of the knowledge to ensure its validity and reliability. The authentication process may include cross-referencing with existing validated knowledge, assessing the credibility of the SME 101, and/or verifying the consistency of the knowledge provided.

At block 406, an efficiency index is generated for individual uses of the knowledge. The efficiency index measures a sequence and efficiency of decisions and approaches taken towards solving a problem. The efficiency index provides a measurable, objective metric to validate the knowledge received from the SME 101, ensuring that the knowledge is not only accurate but also practically useful in various contexts.

At block 408, the authenticated knowledge and the efficiency index are stored, such as in the knowledge management system 122. The authenticated knowledge represents know-how that can be distributed with a level of certainty about its usability as indicated by the efficiency index. Storing the authenticated knowledge and the efficiency index in a database ensures that the knowledge is readily accessible for future use by various users and can be reliably referenced in decision-making processes.

At block 410, a trained machine learning model (e.g., using the LLM agent 120) is used to generate a response to a user query (e.g., “prompt”) using the authenticated knowledge and the efficiency index. This step leverages the validated and ranked knowledge to provide accurate and reliable responses to user queries, enhancing the overall decision-making process responses by the AI-assisted system (e.g., the LLM agent 120) by ensuring that the information provided is both valid and useful.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor(s) 521 of FIG. 5) of a computing system (e.g., the processing system 500 of FIG. 5), cause the processor to perform the processes described herein.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 529 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for knowledge authentication for artificial intelligence-assisted decision making, comprising:
receiving knowledge from a subject matter expert;
authenticating the knowledge based on structured decision-making information;
generating an efficiency index for individual uses of the knowledge, wherein the efficiency index measures a sequence and efficiency of decisions and approaches taken towards solving a problem;
storing authenticated knowledge and the efficiency index, wherein the authenticated knowledge represents know-how that can be distributed with a level of certainty about its usability; and
generating, using a trained machine learning model, a response to a user query using the authenticated knowledge and the efficiency index.

2. The computer-implemented method of claim 1, wherein the knowledge comprises at least one of an opinion, an approach to the problem, or a recommendation.

3. The computer-implemented method of claim 1, wherein the knowledge is implicit knowledge, wherein the trained machine learning model generates the response using the authenticated knowledge and the efficiency index.

4. The computer-implemented method of claim 1, wherein the efficiency index is one of a plurality of efficiency indices for solving the problem.

5. The computer-implemented method of claim 4, further comprising ranking the plurality of efficiency indices for solving the problem.

6. The computer-implemented method of claim 5, wherein the ranking is based at least in part on a confidence of each of the plurality of efficiency indices solving the problem.

7. The computer-implemented method of claim 1, wherein generating the efficiency index is performed using a random walk model.

8. The computer-implemented method of claim 1, wherein the efficiency index is calculated using the following equation:
$${\sum }_{0}^{m} {\prod }_{0}^{n} {( {D}_{n} {PA}_{n} )}_{m}$$
where m is a number of branches, n is a total number of nodes per branch, and PA represents a P index or A index value for a given n and m.

9. A processing system comprising:
a memory comprising computer readable instructions; and
a processing device for executing the computer readable instructions, the computer readable instructions controlling the processing system to perform operations for knowledge authentication for artificial intelligence-assisted decision making, the operations comprising:
receiving knowledge from a subject matter expert;
authenticating the knowledge based on structured decision-making information;
generating an efficiency index for individual uses of the knowledge, wherein the efficiency index measures a sequence and efficiency of decisions and approaches taken towards solving a problem;
storing authenticated knowledge and the efficiency index, wherein the authenticated knowledge represents know-how that can be distributed with a level of certainty about its usability; and
generating, using a trained machine learning model, a response to a user query using the authenticated knowledge and the efficiency index.

10. The processing system of claim 9, wherein the knowledge comprises at least one of an opinion, an approach to the problem, or a recommendation.

11. The processing system of claim 9, wherein the knowledge is implicit knowledge, wherein the trained machine learning model generates the response using the authenticated knowledge and the efficiency index.

12. The processing system of claim 9, wherein the efficiency index is one of a plurality of efficiency indices for solving the problem.

13. The processing system of claim 12, the operations further comprising ranking the plurality of efficiency indices for solving the problem.

14. The processing system of claim 13, wherein the ranking is based at least in part on a confidence of each of the plurality of efficiency indices solving the problem.

15. The processing system of claim 9, wherein generating the efficiency index is performed using a random walk model.

16. The processing system of claim 9, wherein the efficiency index is calculated using the following equation:
$${\sum }_{0}^{m} {\prod }_{0}^{n} {( {D}_{n} {PA}_{n} )}_{m}$$
where m is a number of branches, n is a total number of nodes per branch, PA represents a P index or A index value for a given n and m.

17. A computer program product comprising a computer readable storage medium having program instructions embodied therewith, the program instructions executable by at least one processor to cause the at least one processor to perform operations for performing knowledge authentication for artificial intelligence-assisted decision making, the operations comprising:
receiving knowledge from a subject matter expert;
authenticating the knowledge based on structured decision-making information;
generating an efficiency index for individual uses of the knowledge, wherein the efficiency index measures a sequence and efficiency of decisions and approaches taken towards solving a problem;
storing authenticated knowledge and the efficiency index, wherein the authenticated knowledge represents know-how that can be distributed with a level of certainty about its usability; and
generating, using a trained machine learning model, a response to a user query using the authenticated knowledge and the efficiency index.

18. The computer program product of claim 17, wherein the efficiency index is one of a plurality of efficiency indices for solving the problem, wherein the operations further comprise ranking the plurality of efficiency indices for solving the problem, and wherein the ranking is based at least in part on a confidence of each of the plurality of efficiency indices solving the problem.

19. The computer program product of claim 17, wherein generating the efficiency index is performed using a random walk model.

20. The computer program product of claim 17, wherein the efficiency index is calculated using the following equation:
$${\sum }_{0}^{m} {\prod }_{0}^{n} {( {D}_{n} {PA}_{n} )}_{m}$$
where m is a number of branches, n is a number of nodes per branch, PA represents a P index or A index value for a given n and m.
